(19) United States
(12) Patent Application Publication
(10) Pub. No.: US 2016/0116023 A1
(43) Pub. Date: Apr. 28, 2016

(54) RIGHT ANGLE DRIVE HAVING DUAL SHAFT BEARINGS

(71) Applicants: Darren P. Eisinger, Carpentersville, IL (US); David Aaron Larson, St. Charles, IL (US)

(72) Inventors: Darren P. Eisinger, Carpentersville, IL (US); David Aaron Larson, St. Charles, IL (US)

(73) Assignee: NOMIS LLC, Elgin, IL (US)

(21) Appl. No.: 14/523,170

(22) Filed: Oct. 24, 2014

(51) Int. Cl. F16H 1/12

(52) U.S. Cl. CPC F16H 1/12

(57) ABSTRACT

A right-angle drive having dual shaft bearings is provided. The right-angle drive includes a pair of transmission assemblies that each have a shaft. Each shaft is supported by multiple bearings to enhance the load-bearing capabilities of the transmission assemblies.

### FIELD OF THE INVENTION

This invention generally relates to hand tools and more particularly to right angle drives.

### BACKGROUND OF THE INVENTION

Right angle drives are particularly useful when drilling holes in confined spaces such as inside corners and the like. Right angle drives are commonly used to transmit a driving torque from a first axis to a second axis disposed at a right angle to the first axis. These drives typically incorporate a power transmission mechanism to achieve this functionality.

A typical power transmission mechanism for a right angle drive includes a pair of shafts arranged generally perpendicular to one another. A gear is connected to one end of each shaft. The shafts are arranged such that the gears mesh. As a result, rotation of one shaft causes a like rotation in the other shaft. Each shaft is also typically supported by a bearing. The bearing is often times press fit to the shaft, and defines an outer most periphery of the shaft and bearing assembly. Each shaft carrying a gear and bearing is then installed in a housing. The housing typically has an internal cavity that houses the gears, bearings, and a portion of the shafts.

Unfortunately, if one bearing fails, the entire power transmission mechanism becomes inoperable. Disassembly of the housing, shafts, gears, and bearings is generally not an option due to the press fit between the bearing and the shaft. Moreover, in many designs the bearings are press fit into the housing after they have been press fit onto the shaft thereby making disassembly even more difficult. As such, bearing failure can often times render an entire right angle drive inoperable and necessitate the replacement of the same.

Due to the transmission mechanism requiring shafts gears and bearings, a right angle drive may also be bulky and unwieldy, which may make it difficult or even impossible for the right angle drive to be used in a confined space.

In view of the above, there is a need in the art for a right angle drive that has a heightened resistance to bearing failure. Further, there is the need to provide a compact and easy to use right angle drive. Embodiments of the invention provides such a right angle drive. These and other advantages of the invention, as well as additional inventive features, will be apparent from the description of the invention provided herein.

### BRIEF SUMMARY OF THE INVENTION

In view of the above, embodiments of the present invention provide a right-angle drive with dual shaft bearings that overcome existing problems in the art. More particularly, embodiments of the present invention provide a new and improved right-angle drive having enhanced bearing failure resistance by incorporating transmission shafts supported by multiple bearings.

In one embodiment, a right-angle drive is provided. The right-angle drive includes at least one shaft configured to transmit an input torque to an output end of the right-angle drive. The at least one shaft has a gear portion and a bearing portion. The gear portion extends away from the bearing portion and terminates at an end of the shaft. The bearing portion has a length greater than a length of the gear portion. At least one bearing is mounted to the at least one shaft on the bearing portion thereof and radially supports the shaft.

In another embodiment, the gear portion has a first diameter and the bearing portion has a second diameter, wherein the first diameter less than the second diameter.

In another embodiment, the right-angle drive further includes a housing. The at least one bearing has an outer periphery that defines a bearing support region. The bearing support region contacts an internal cavity of the housing. The bearing portion and gear portion of the at least one shaft are internally disposed within the cavity of the housing.

In another embodiment, the bearing support region extends a length greater than 50% of the length of the bearing portion. In another embodiment, the bearing support region extends a length greater than 75% of the length of the bearing portion. In another embodiment, the bearing support region extends a length greater than 90% of the length of the bearing portion.

In another embodiment, a right-angle drive is provided. The right-angle drive includes at least one shaft operable to transfer an input torque from a first end of the right-angle drive to a second end of the right-angle drive. The at least one shaft has an abutment. At least one bearing is carried by and regularly supports the shaft. The at least one bearing is in abutted contact with the abutment. The at least one bearing has an outer periphery providing a bearing region that has a first axial length. The bearing region extends axially away from the abutment. A first gear is carried by the shaft and is operable to mesh with a second gear at a mesh point. The mesh point is axially spaced away from the abutment at a second axial length. The bearing region extends between the abutment and the gear. A bearing support ratio is defined by the first axial length relative to the second axial length.

In another embodiment, the bearing support ratio is greater than about 0.5 to about 1. In another embodiment, the bearing support ratio is greater than about 0.65 to about 1. In another embodiment, the bearing support ratio is greater than about 0.75 to about 1.

In another embodiment, a right-angle drive is provided. The right-angle drive includes a first shaft having an abutment and a second shaft also having an abutment. A first gear is mounted to the first shaft. A second gear is mounted to the second shaft, and the gears mesh to operably transfer an input torque between the first and second shafts. A plurality of bearings support the first shaft between the abutment of the first shaft and the first gear. Similarly, a plurality of bearings support the second shaft between the abutment of the second shaft and the second gear.

In another embodiment, each one of the first plurality of bearings extends away from the abutment beginning with a first one of the plurality of bearings in abutted contact with the abutment of the first shaft and ending at a last one of the first plurality of bearings axially spaced the farthest away from the abutment of the first shaft. Each one of the second plurality of bearings extends away from the abutment beginning with a first one of the first plurality of bearings in abutted contact with the abutment of the second shaft and ending at a last one of the second plurality of bearings axially spaced the farthest away from the abutment of the second shaft.

In another embodiment, a first number of bearings of the first plurality of bearings is equal to a second number of bearings of the second plurality of bearings. In another embodiment, the first number of bearings is at least two bearings.

In another embodiment, the first and second shafts each have a connection region, a load-bearing region, and a radially outwardly extending flange separating the connection region and the load-bearing region. The abutment of the first shaft is provided by the flange of the first shaft and the abutment of the second shaft is provided by the flange of the second shaft.

In another embodiment, the load-bearing region of each of the first and second shafts has a gear portion and a bearing portion. The first plurality of bearings are mounted to the gear portion of the first shaft. The second plurality of bearings are mounted to the gear portion of the second shaft.

In another embodiment, the gear portion of the first shaft has an axial length shorter than an axial length of the bearing portion of the first shaft. The gear portion of the second shaft has an axial length shorter than an axial length of the bearing portion of the second shaft.

In another embodiment, the gear portion of the first shaft has a diameter less than a diameter of the bearing portion of the first shaft. The gear portion of the second shaft has a diameter less than a diameter of the bearing portion of the second shaft. In another embodiment, the flange of the first shaft has a diameter greater than the diameters of the gear and bearing portions of the first shaft. The flange of the second shaft has a diameter greater than the diameters of the gear and bearing portions of the second shaft.

In another embodiment, the connection region of the first shaft is operably coupled to an input shaft for providing the input torque. The connection region of the second shaft is operably coupled to a chuck of the right-angle drive.

In another embodiment, an angle drive attachment is provided. The angle drive attachment according to this embodiment includes a housing and an input shaft. A pair of input bearings are rotatably mounted to the input shaft within the housing for rotation about an input axis. The angle drive attachment further includes an output shaft. A pair of output bearings are rotatably mounted to the output shaft within the housing for rotation about an output axis that is non-parallel to the input axis. The input shaft is operably coupled to the output shaft to transmit torque there between.

In another embodiment, the angle drive further includes an input gear attached to a cantilevered portion of the input shaft. The angle drive also includes an output gear mating with the input gear and attached to a cantilevered portion of the output shaft. In another embodiment, the input and output gears are bevel gears.

In another embodiment, the input bearings are at different axial locations along the input axis and the output bearings are at different axial locations along the output axis. In another embodiment, the input bearings axially abut and the output bearings axially abut. In another embodiment, the input bearings are axially spaced apart along the input axis and the output bearings are axially spaced apart along the output axis. In another embodiment, the input and output axes are perpendicular.

In another embodiment, the housing includes an input abutment and the input shaft includes an input shaft abutment. The input bearings are axially positioned between the input abutment and the input shaft abutment. One bearing contacts the input abutment and one bearing contacts the input shaft abutment. In another embodiment, the bearings include a roller element.

In another embodiment, a right angle drive is provided. The right angle drive comprises at least one shaft having a first end, a second end and a first bearing portion. The shaft is configured to transmit an input torque to an output end of the right angle drive. The right angle drive further comprises a first bearing mounted to the at least one shaft on the first bearing portion and radially supports the shaft. The right angle drive further comprises a second bearing, the second bearing being a thrust bearing configured to at least axially support the at least one shaft over a second bearing portion.

In another embodiment, the second bearing supports the shaft against a thrust from the second end to the first end of the shaft. In another embodiment, an end piece is provided. The end piece provides the second bearing portion for the second bearing and the shaft has at its first end a connection region for connecting the shaft to the end piece. In another embodiment, the end piece has a receiving portion for receiving the first connection region of the first end of the shaft. In another embodiment, the end piece has a flange adjacent to the second bearing portion, a diameter of the second bearing portion being smaller than a diameter of the flange portion. In another embodiment, the end piece is a separate piece from the shaft. In another embodiment, the second bearing is in abutted contact with an abutment of the flange of the end piece.

In another embodiment, the shaft has a flange adjacent to the first bearing portion and a diameter of the first bearing portion is smaller than a diameter of the flange of the shaft. In another embodiment, the first bearing is in abutted contact with an abutment of the flange of the shaft.

In another embodiment, the shaft comprises a gear portion adjacent to the flange of the shaft. In another embodiment, the gear portion is arranged between the first bearing portion and the first end of the shaft. In another embodiment, a diameter of the gear portion is smaller than a diameter of the flange of the shaft. In another embodiment, a diameter of the gear portion is smaller than a diameter of the first bearing portion. In another embodiment, the right angle drive further comprises a gear mounted on the gear portion of the shaft, wherein the gear is in abutted contact with an abutment of the flange of the shaft. In another embodiment, the gear is a bevel gear and an outer periphery of the gear is substantially tapering in a direction from the second end of the shaft to the first end of the shaft.

In another embodiment, the shaft has at its second end a connection region for connection of a chuck. In another embodiment, at least one of the first bearing and the second bearing is a ball bearing.

In another embodiment, the right angle drive further comprises a housing, wherein the first and the second bearing have an outer periphery that define bearing support regions. The bearing support regions contact an internal cavity of the housing, and the first and second bearing portion and the gear portion of the shaft are internally disposed within the cavity of the housing.

In another embodiment, a right angle drive is provided. The right angle drive comprises at least one shaft operable to transfer an input torque from a first end of the right angle drive to a second end of the right angle drive. The at least one shaft has a flange, and the flange is arranged between a bearing portion and a gear portion of the at least one shaft. At least one bearing is mounted on a bearing portion and radially supports the shaft and is in abutted contact with a first side abutment of the flange. The bearing portion extends axially away from the first side abutment of the flange. A first gear is carried by the shaft on a gear portion, operable to mesh with a second gear at a mesh point and in abutted contact with a second side abutment of the flange. The gear portion extends axially away from the second side abutment of the flange.

In another embodiment, one bearing is mounted on the bearing portion and the ratio between the bearing portion relative to the gear portion is between 0.5 and 1.5. In another embodiment, at least a second bearing is provided. The second bearing is a thrust bearing configured to axially support the at least one shaft over a second bearing portion. In another embodiment, an end piece is provided. The end piece provides the second bearing portion for the second bearing and the shaft has at a first end a connection region for connecting the shaft to the end piece.

In another embodiment, at least two bearings are mounted on the bearing portion and the ration between the bearing portion relative to the gear portion is larger than 1.5. In another embodiment, the gear portion forms a first end of the shaft and has a substantially flat end face. In another embodiment, the gear is flush with the end face of the first end.

In another embodiment, a right angle drive is provided. The right angle drive comprises a first shaft having a flange, a second shaft having a flange, a first gear mounted to the first shaft and a second gear mounted to the second shaft. The gears meshing to operably transfer an input torque between the first and the second shafts. The right angle drive further comprises a first number of bearings supporting the first shaft. The flange of the first shaft is arranged between the first gear and the first number of bearings. The right angle drive further comprises a second number of bearings supporting the second shaft. The second number of bearings is at least two. The flange of the second shaft and the second gear are arranged between the second number of bearings.

In another embodiment, the first number of bearings is at least two. The first number of bearings is mounted on a bearing region of the first shaft adjacent the flange of the first shaft. In another embodiment, at least one of the second number of bearings is mounted on a bearing region of the second shaft adjacent the flange of the second shaft. In another embodiment, at least one of the second number of bearings is mounted on a bearing region of an end piece. In another embodiment, the shaft has at a first end a connection region for connecting the shaft to the end piece. The end piece has a flange adjacent to the bearing portion of the end piece. A diameter of the second bearing portion is smaller than a diameter of the flange. In another embodiment, the at least one bearing of the second number of bearings is mounted on an end piece. The at least one bearing of the second number of bearings is a thrust bearing configured to at least axially support the second shaft against a thrust from a second end to the first end of the second shaft. In another embodiment, the first shaft is operably coupled to an input shaft providing the input torque. The second shaft is operably coupled to a chuck of the right angle drive.

In another embodiment, a right angle drive is provided, the right angle drive comprises a housing. The right angle drive further comprises an input shaft rotatably mounted within the housing for rotation about an input axis. The right angle drive further comprises an output shaft rotatably mounted within the housing for rotation about an output axis. The input shaft is operably coupled to the output shaft to transmit torque there between. The right angle drive further comprises a handle attached to the housing. The handle is at least partially rotatable about an axis of rotation, such that the handle is at least partially rotatable about the housing.

In another embodiment, the axis of rotation is one of the input and the output axis. In another embodiment, the handle is attached to the housing over a ring element. The handle and the ring are commonly rotatable over the axis of rotation. In another embodiment, an axis of the handle is substantially perpendicular to the axis of rotation. In another embodiment, at least one of the handle and the ring element has a fixation mechanism for fixing the position of the handle relative to the housing. In another embodiment, the handle and the ring each comprise a thread, such that the handle can be screwed into the ring element fixing the position of the handle relative to the housing. In another embodiment, the housing comprises indicators indicating predefined positions of the handle relative to the housing.

Other aspects, objectives and advantages of the invention will become more apparent from the following detailed description when taken in conjunction with the accompanying drawings.

### BRIEF DESCRIPTION OF THE DRAWINGS

The accompanying drawings incorporated in and forming a part of the specification illustrate several aspects of the present invention and, together with the description, serve to explain the principles of the invention. In the drawings:

FIG. 1 is a perspective view of an exemplary embodiment of a right-angle drive according to the teachings of the present invention, connected to a power drill;

FIG. 2 is an exploded perspective view of the right-angle drive of FIG. 1;

FIG. 3 is a side cross-sectional view of a first shaft of the right-angle drive of FIG. 1;

FIG. 4 is a side cross-sectional view of a second shaft of the right-angle drive of FIG. 1;

FIG. 5 is a side cross-sectional view of the shaft of FIG. 3 with a pair of bearings and a gear mounted thereon;

FIG. 6 is a side cross-sectional view of the shaft of FIG. 4 with a pair of bearings and a gear mount thereon;

FIG. 7 is a side cross-sectional view of the right-angle drive of FIG. 1;

FIG. 8 is a perspective view of a second exemplary embodiment of a right-angle drive according to the teachings of the present invention;

FIG. 9 is an exploded perspective view of the right-angle drive of FIG. 8;

FIG. 10 is a side cross-sectional view of a first shaft of the right-angle drive of FIG. 8;

FIG. 11 is a side cross-sectional view of a second shaft with an end piece of the right-angle drive of FIG. 8;

FIG. 12 is a side cross-sectional view of the shaft of FIG. 10 with two bearings and a gear mounted thereon;

FIG. 13 is a side cross-sectional view of the shaft and the end piece of FIG. 11 with two bearings and a gear mount thereon;

FIG. 14 is a side cross-sectional view of the right-angle drive of FIG. 8;

FIG. 15 is another exploded perspective view of the right-angle drive of FIG. 8; and

FIG. 16 is a back cross-sectional view of the right-angle drive of FIG. 8.

While the invention will be described in connection with certain preferred embodiments, there is no intent to limit it to those embodiments. On the contrary, the intent is to cover all alternatives, modifications and equivalents as included within the spirit and scope of the invention as defined by the appended claims.

### DETAILED DESCRIPTION OF THE INVENTION

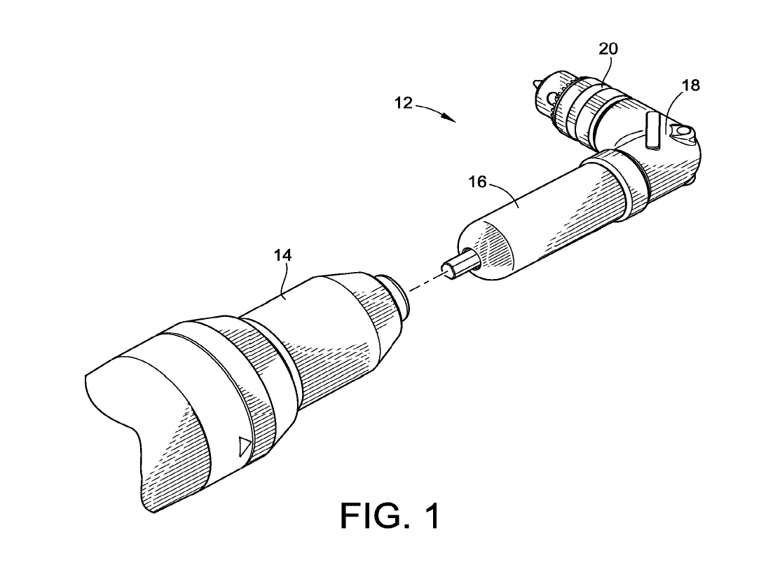

Turning now to the drawings, there is illustrated in FIG. 1, a right-angle drive 12 connected to a drill 14. While the following description will reference the advantages and benefits of the right-angle drive 12 in combination with a typical drill 14 (e.g. a power drill), it is recognized that the right-angle drive 12 may be utilized in other applications such as milling or manual processes.

The right-angle drive 12 has a handle 16 connected to one end of an elbow 18. A chuck 20 is connected to an opposite end of the elbow 18. As such, a center axis of the chuck 20 is generally 90 degrees relative to a center axis of the handle 16.

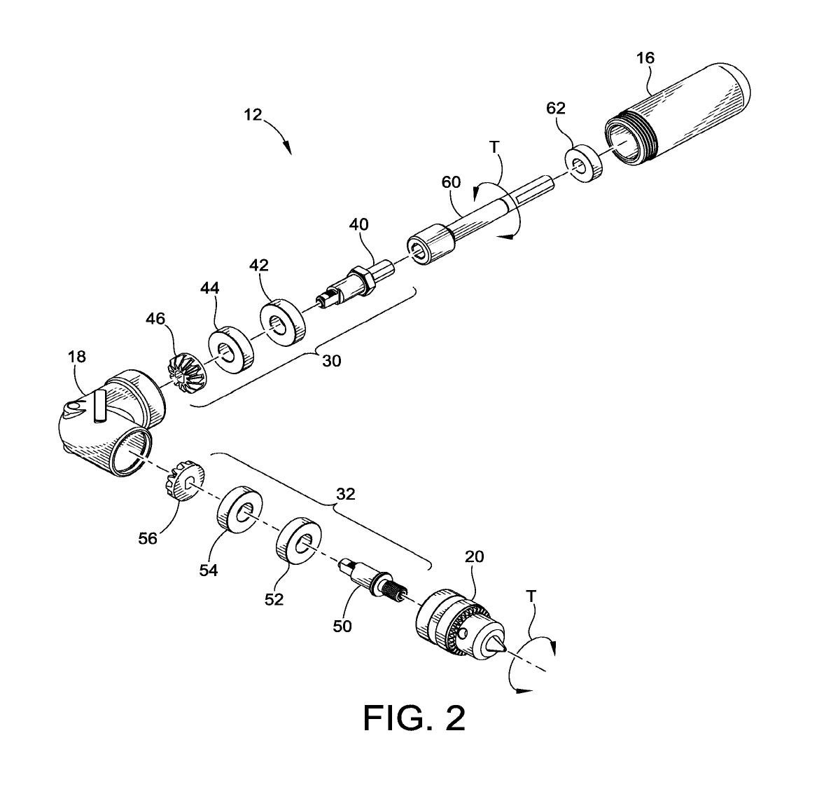

Turning now to FIG. 2, the right-angle drive 12 has first and second transmission assemblies 30, 32. The first and second transmission assemblies 30, 32 are mechanically connected and operable to transmit a torque from an input shaft 60 to the chuck 20. As will be discussed in greater detail below, the right angle drive 12 is operable to transmit an input torque supplied by the drill 14 to the chuck 20.

The right angle drive 12 has first and second transmission assemblies 30, 32. The first transmission assembly 30 has a shaft 40, a pair of bearings 42, 44, and a gear 46. The bearings 42, 44 and gear 46 are a affixed to the shaft 40. The gear 46 is affixed such that is does not rotate relative to the shaft 40.

Similarly, the second transmission assembly 32 has a shaft 50, a pair of bearings 52, 54, and a gear 56. The bearings 52, 54 and gear 56 are affixed to the shaft 50. The gear 56 is affixed such that it does not rotate relative to the shaft 50. The type and number of bearings used in the first transmission assembly 30 may be the same or different from that used in the second transmission assembly 32.

The gears 46, 56 mesh internally within the elbow 18 which forms a gear housing. The shaft 40 of the first transmission assembly 30 is radially supported by the bearings 42, 44 internally within the elbow 18. Similarly, the shaft 50 of the second transmission assembly 32 is radially supported by the bearings 52, 54 of the second transmission assembly 32 within the elbow 18.

The use of multiple bearings to support each shaft 40, 50 results in better load distribution throughout the first and second transmission assemblies 30, 32 such that the right-angle drive 12 has a longer service life than prior designs. More particularly, using multiple bearings to support each shaft 40, 50 reduces the likelihood of failure of any one of the bearings supporting the same, or the shafts 40, 50.

In a preferred embodiment, the bearings 42, 44, 52, 54 are rolling element bearings. However, in other embodiments, they could be other types of bearings, or bushings.

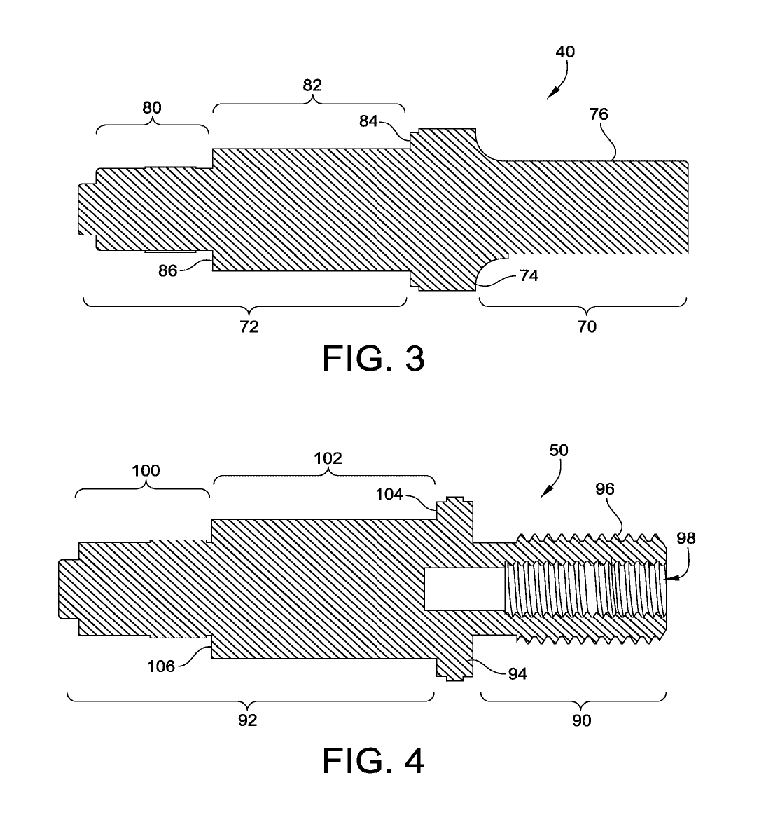

With reference now to FIG. 3, the shaft 40 of the first transmission assembly (see FIG. 2) has a connection region 70 and a load-bearing region 72 separated by a flange 74. The connection region 70 connects to the input shaft 60 of the right-angle drive (see FIG. 2). The connection region 70 of the shaft 40 has an outer periphery 76. The shape of the outer periphery 76 is defined by a cross-sectional profile of the shaft 40 in the connection region 70. The profile can be round, hexagonal, triangular, or other profiles commonly used in the connection of rotational mechanisms.

The load-bearing region 72 of the shaft 40 has a gear portion 80 for receiving the gear 46 (see FIG. 2) in abutted contact with a gear abutment surface 86 of the shaft 40. The load-bearing region 72 also has a bearing portion 82 for receiving the bearings 42, 44 (see FIG. 2), with one bearing 42 in abutted contact with an abutment surface 84 (see FIG. 2). In the illustrated embodiment, the abutment surface 84 is provided by the flange 74.

With reference to FIG. 4, the shaft 50 of the second transmission assembly 32 also has a connection region 90 and a load-bearing region 92 separated by a flange 94. The connection region 90 has a threaded outer periphery 96 to receive the chuck 20 (see FIG. 1). The connection region 90 also has a threaded hole 98, also used for mounting the chuck 20 (see FIG. 1) to the shaft 50.

The load-bearing region 92 has a gear portion 100 and a bearing portion 102. The gear 56 of the second transmission assembly 32 (see FIG. 2) mounts to the gear portion 100 in abutted contact with a gear abutment surface 106 of the shaft 50. The bearings 52, 54 of the second transmission assembly (see FIG. 2) mount to the bearing portion 102, with one bearing 52 in abutted contact with a bearing abutment surface 104 of the flange 94 of the shaft 50.

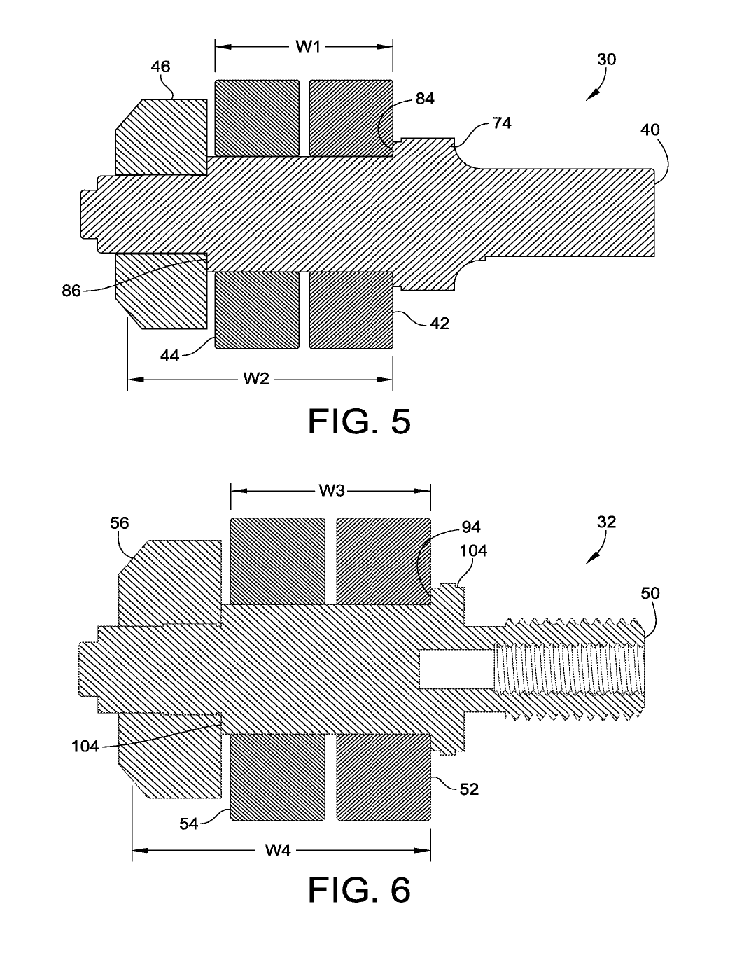

With reference to FIG. 5, the bearings 42, 44 of the first transmission 30 (see FIG. 2) are illustrated mounted on the shaft 40. The bearings 42, 44 can be mounted on the shaft 40 using a press fit to insure sufficient contact of the shaft 40 relative to the bearings 42, 44. The bearings 42, 44 can be embodied as a variety of rolling element bearings such as ball bearings, roller bearings, needle bearings, or even bushings. Additionally, each one of the bearings 42, 44 may be different or the same type of bearing as each other one of the bearings 42, 44.

When mounted to the shaft 40, the bearings 42, 44 can abut against one another or be spaced apart with one bearing 42 abutting against the abutment surface 84 of the shaft 40. When installed as illustrated, the bearings provide a bearing support region taken from the abutment surface 84 to an outer edge of the bearing 44 farthest away from the abutment surface 84 and having a width denoted as W1.

The gear 56 of the first transmission assembly 30 is also illustrated mounted to the shaft 40. The gear 56 may be mounted to the shaft 40 using a press fit to insure sufficient contact between the shaft 40 and the gear 56. The gear 46 may be a bevel gear or other gear typically used to transfer torque between non-parallel axes.

A distance from a mesh point of the gear 46 to the abutment surface 84 is denoted as width W2. The ratio of W1 to W2 can be used to characterize the enhanced load-bearing capabilities of the first transmission mechanism 30. In one embodiment, this ratio is about 0.5 to 1. More preferably, this ratio is about 0.65 to 1. Still more preferably, this ratio is about 0.75 to 1.

The width W1 relative to the total width of the bearing portion 82 (see FIG. 3) can also be used to characterize the enhanced load-bearing capabilities of the first transmission assembly 30. In one embodiment, the width W1 of the bearings 42, 44 taken from the abstract surface 84 is greater than 50% of the width of the bearing portion 82 (see FIG. 3). More preferably, the width W1 of the bearings 42, 44 taken from the abutment surface is greater than 75% of the width of the bearing portion 82 (see FIG. 3). Still more preferably, the width W1 of the bearings 42, 44 taken from the abutment surface 84 is greater than 90% of the width of the bearing portion 82 (see FIG. 3).

Turning now to FIG. 6, in a similar manner as that discussed above with respect to FIG. 5, the bearings 52, 54 of the second transmission assembly 32 can be press fit to the shaft 50. The bearings 52, 54 may be embodied as various rolling element type bearings such as ball bearings, roller bearings, needle bearings, or bushings, etc. Additionally, each one of the bearings 52, 54 may be different or the same type of bearing as each other one of the bearings 52, 54.

When installed, the bearings 52, 54 define a bearing support region that extends from the abutment surface 104 out to the outermost edge of the bearing 54 farthest away from the abutment surface 104 and denoted by width W3.

The gear 56 can be mounted to the shaft 50 also using a press fit to insure sufficient contact between the gear 56 and the shaft 50. A distance from the abutment surface 104 out to a meshing point of the gear 56 is denoted as width W4. As was the case with the first transmission assembly 30 discussed above with reference to FIG. 5, the ratio between widths W3 and W4 can be used to characterize the enhanced load-bearing capabilities of the second transmission assembly 32. In one embodiment, this ratio is preferably 0.5 to 1. More preferably, this ratio is 0.65 to 1. Still more preferably, this ratio is about 0.75 to 1.

The width W2 relative to the total width of the bearing portion 102 (see FIG. 4) can also be used to characterize the enhanced load-bearing capabilities of the second transmission assembly 32. In one embodiment, width W2 of the bearings 52, 54 taken from the abstract surface 104 is greater than 50% of the width of the bearing portion 102 (see FIG. 4). More preferably, the width W2 of the bearings 52, 54 taken from the abutment surface is greater than 75% of the width of the bearing portion 102 (see FIG. 4). Still more preferably, the width W2 of the bearings 52, 54 taken from the abutment surface 104 is greater than 90% of the width of the bearing portion 102 (see FIG. 4).

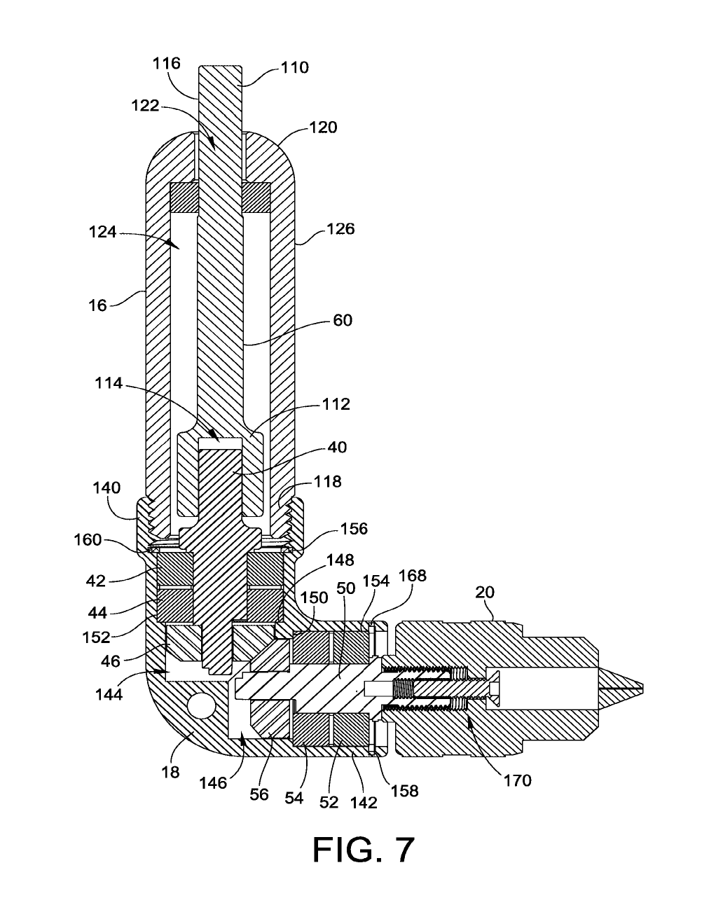

Turning now to FIG. 7, the input shaft 60 is used to transmit a torque through the first and second transmission assemblies 30, 32 (see FIG. 2) to the chuck 20. The input shaft 60 has a first end 110 and a second end 112. The first end 110 has an outer peripheral surface 116. The outer peripheral surface 116 is defined by a cross-sectional profile that can be straight, hexagonal, triangular, or any other profile commonly used in rotational mechanisms. The second end 112 has an opening 114 therein. The opening 114 is used to connect the input shaft 60 to the connection region (see FIG. 3) of the shaft 40 of the first transmission assembly 30 (see FIG. 2).

The handle 16 has a first end 118 and a second end 120. The second end 120 has a bore 122 passing therethrough to allow the first end 110 of the input shaft 60 to extend from the handle 16 for connection to a drill 14 (see FIG. 1) or similar device. The first end 118 is threaded for connecting the handle 16 to the elbow 18. The remainder of the input shaft 60 is disposed within a cavity 124 of the handle 16. As illustrated in FIG. 7, the cavity 124 of the handle 16 also carries an input bearing 62 that support the input shaft 60. Also, as illustrated in FIG. 7, the connection between the shaft 40 of the first transmission assembly 30 (see FIG. 2) and the input shaft 60 occurs within the cavity 124 of the handle 16.

The handle 16 also has an outer peripheral surface 126. The outer peripheral surface 126 can be smooth or include other surface features such as finger indentations, gratings, rubberized grips, etc. Additionally, the handle 16 is generally interchangeable with other handles by removing the handle 16 from the elbow 18 and replacing it with a different handle.

The elbow 18 has a first end 140 and second end 142. The first end threadably receives the handle 16. The chuck 20 mounts to the shaft 50 of the second transmission assembly 32 (see FIG. 2) proximate the second end 142 of the elbow 18.

The elbow 18 has first and second cavities 144, 146 internally therein. The first and second cavities 144, 146 are in communication with one another. The gear 46 and bearings 42, 44 of the first transmission assembly 30 (see FIG. 2) are disposed within the first cavity 144. The gear 56 and bearings 52, 54 of the second transmission assembly 32 (see FIG. 2) are disposed within the second cavity 146. The gears 46, 56 mesh at the union of the first and second cavities 144, 146.

The first cavity 144 has an abutment surface 148 that the bearing 44 farthest away from the abutment 84 of the shaft 40 of the first transmission assembly 30 (see FIG. 2) abuts against. When fully installed, the bearings 42, 44 are in surface contact with a bearing surface 152 having a similar width as width W3 of the FIG. 5. The bearings 42, 44 may be installed within the first cavity 144 by a press fit to insure sufficient engagement with the first cavity 144. Additionally, the first cavity 144 can also include a groove 156 for receipt of a retainer ring 160 to insure the bearings 42, 44 are sufficiently retained within the first cavity 144.

The second cavity 146 also has an abutment surface 150. The bearings 54, 56 of the second transmission assembly 32 (see FIG. 2) abut against the abutment 150 of the second cavity 146. When fully installed, the bearings 54, 56 are in contact with a bearing surface 152 of the second cavity 146. The bearing surface 154 has a substantially similar length as width W3 of FIG. 6. The bearings 54, 56 may be press fit within the second cavity 146 to insure sufficient engagement with the elbow 18. Additionally, the second cavity 146 can also include a groove 158 that receives a retainer ring 168 to aid in retaining the second transmission assembly 32 (see FIG. 2) within the second cavity 146.

The connection region 90 (see FIG. 4) extends from the second end 142 of the elbow 18. The chuck 20 has a threaded bore 170 to threadably engage the connection region 90 of shaft 50.

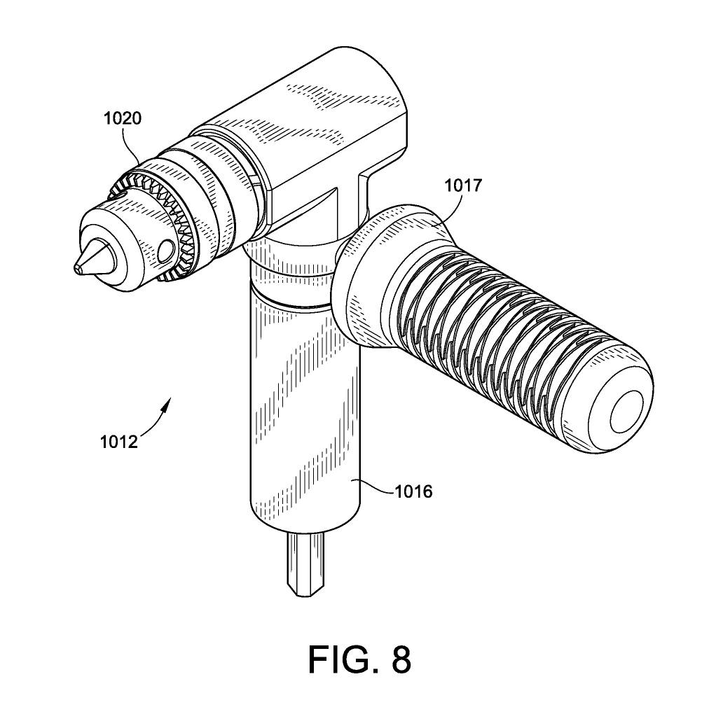

Turning now to a second embodiment of the right angle drive, there is illustrated in FIG. 8 a right-angle drive 1012. In the following, in particular the differences to the right angle drive 12 of the first embodiment will be highlighted and described. However, aspects which may only be described with respect to the first embodiment of the right angle drive 12 may also be applicable and compatible with the second embodiment of the right angle drive 1012, and vice versa.

As in FIG. 1, the right angle drive 1012 may also be used for connection to a drill 14 (see FIG. 1) or it may be utilized in other applications such as milling or manual processes. In contrast to the first embodiment, the right-angle drive 1012 has not only a handle 1016 connected to one end of an elbow 1018 but also an (additional) handle 1017 connected to a lower part of the elbow 1018. A chuck 1020 is connected to an opposite end of the elbow 1018. As such, a center axis of the chuck 1020 is generally 90 degrees relative to a center axis of the handle 1016.

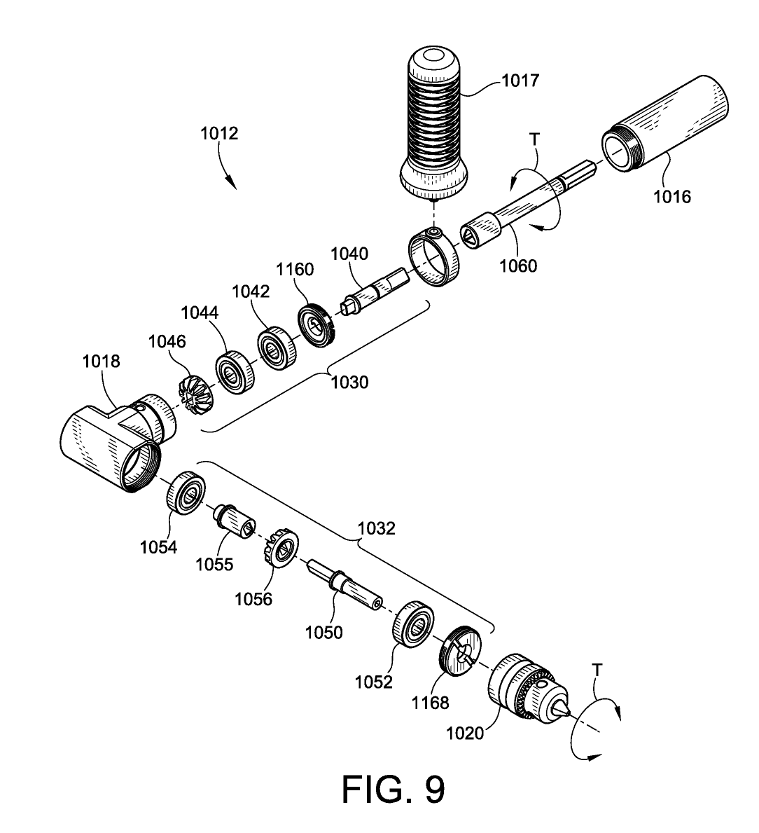

Turning now to FIG. 9, the right-angle drive 1012 has first and second transmission assemblies 1030, 1032. The first and second transmission assemblies 1030, 1032 are mechanically connected and operable to transmit a torque from an input shaft 1060 to the chuck 1020. As will be discussed in greater detail below, the right angle drive 1012 is operable to transmit an input torque supplied by a drill (such as drill 14 in FIG. 1) to the chuck 1020. The first transmission assembly 1030 has a shaft 1040, two bearings 1042, 1044, and a gear 1046. The bearings 1042, 1044 and gear 1046 are a affixed to the shaft 1040. The gear 1046 is affixed such that is does not rotate relative to the shaft 1040. Additionally, the transmission assembly 1030 may include a retainer ring 1160, to make sure that in particular the bearings 1042, 1044 are sufficiently retained on the shaft 1040. The ring 1160 has in this case a threaded outer periphery to be screwed into a corresponding threaded inner periphery of the elbow 1018.

Similarly, the second transmission assembly 1032 has a shaft 1050, two bearings 1052, 1054, and a gear 1056. The bearings 1052, 1054 and gear 1056 are affixed to the shaft 1050. The gear 1056 is affixed such that it does not rotate relative to the shaft 1050. The transmission assembly 1032 in this case further comprises an end piece 1055, which can be affixed to the shaft 1050 such that it does not rotate relative to the shaft 1050. Here, the end piece 1055 is designed as a separate part from the shaft 1050. However, it is possible to also provide a shaft 1050 and end piece 1055 as an integral part. In that case the end piece would be a part of the shaft 1050. Additionally, the transmission assembly 1032 may include a retainer ring 1168, to make sure that in particular the bearing 1052 is sufficiently retained on the shaft 1040. The ring 1168 has in this case a threaded outer periphery to be screwed into a corresponding threaded inner periphery of the elbow 1018.

The gears 1046,1056 mesh internally within the elbow 1018 which forms a gear housing. The shaft 1040 of the first transmission assembly 1030 is radially supported by the two bearings 1042, 1044 internally within the elbow 1018. Similarly, the shaft 1050 of the second transmission assembly 1032 is radially supported by the bearing 1052 of the second transmission assembly 1032 within the elbow 1018. The bearing 1054 is designed as a thrust bearing and is configured to at least axially support the shaft 1050 over a bearing portion provided by the end piece 1055 (see FIG. 13). In particular, the bearing 1054 supports the shaft 1050 against a thrust from the second end 1050b to the first end 1050a (see FIG. 11) of the shaft 1050. However, the bearing 1054 may also radially support the shaft 1050 via the end piece 1055 within the elbow 1018.

The use of multiple bearings to support each shaft 1040, 1050 and their axial distribution results in better load distribution throughout the first and second transmission assemblies 1030, 1032 such that the right-angle drive 1012 has a longer service life than prior designs. More particularly, using multiple bearings to support each shaft 1040, 1050 in the configuration illustrated reduces the likelihood of failure of any one of the bearings supporting the same, or the shafts 1040, 1050. Particularly the use of two distanced bearings 1052, 1054 for shaft 1050 provides for a better load distribution along the shaft 1050 and at the same time bearing 1054 may provide additional axial support for shaft 1050. Due to the specific arrangement and design of the parts of the transmission assemblies 1030, 1032, it is possible to provide a compact right angle drive at the same time.

As already described with respect to the first embodiment, in a preferred embodiment the bearings 1042, 1044, 1052, 1054 are rolling element bearings, in particular ball bearings. However, in other embodiments, they could be other types of bearings, or bushings.

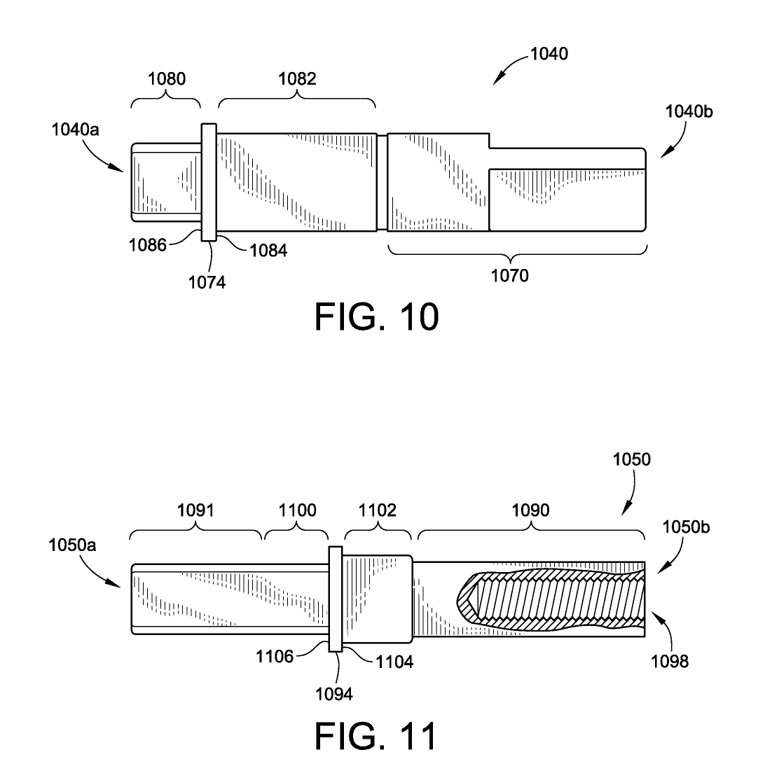

With reference now to FIG. 10, the shaft 1040 of the first transmission assembly 1030 (see FIG. 9) has a connection region 1070 at its second end 1040b. Similar to the first exemplary embodiment, the connection region 1070 connects to the input shaft 1060 of the right-angle drive (see FIG. 9). The connection region 1070 of the shaft 1040 has an outer periphery 1076. The shape of the outer periphery 1076 is defined by a cross-sectional profile of the shaft 1040 in the connection region 1070. The profile can be round, hexagonal, triangular, or other profiles commonly used in the connection of rotational mechanisms.

The shaft 1040 has a gear portion 1080 for receiving the gear 1046 (see FIG. 9) in abutted contact with an abutment surface 1086 of a flange 1074 of the shaft 1040. The gear portion 1080 forms a first end 1040a of the shaft 1040, which has a substantially flat end face. The shaft 1040 also has a bearing portion 1082 for receiving the bearings 1042, 1044 (see FIG. 9), with one bearing 1042 in abutted contact with an abutment 1084 of the flange 1074 (see FIG. 9). In the illustrated embodiment and in contrast to the first embodiment, both the abutment 1084 and the abutment surface 1086 are provided by the flange 1074. In other words, the flange 1074 separates the gear portion 1080 and the bearing portion 1082. The bearing portion 1082 and the gear potion 1080 have diameters which are in each case smaller than the diameter of the flange 1074, while the diameter of the gear potion 1080 is smaller than the diameter of the bearing portion 1082. Further, two bearings 1042, 1044 may be mounted on the bearing portion 1082 (see FIG. 9) and the ratio between the bearing portion 1082 relative to the gear portion 1080 is larger than 1.5.

With reference to FIG. 11, the shaft 1050 of the second transmission assembly 1032 has a first end 1050a and a second end 1050b. The shaft 1050 has a connection region 1091 at its first end 1050a, a connection region 1090 at its second end 1050b, a gear portion 1100 and a bearing portion 1102. The gear portion 1100 and the bearing portion are separated by a flange 1094, that is the gear portion 1100 and the bearing portion 1102 are each adjacent to the flange 1097 of the shaft 1050. The gear portion 1100 is arranged between the first bearing portion 1102 and the first end 1050a of the shaft 1050.

The connection region 1091 adjacent to the gear portion 1100 is used to connect the shaft 1050 to the end piece 1055 (see FIG. 9). The gear 1056 of the second transmission assembly 1032 (see FIG. 9) mounts to the gear portion 1100 in abutted contact with a gear abutment surface 1106 of the flange 1094 of the shaft 1050. The bearing 1052 of the second transmission assembly 1032 (see FIG. 2) mounts to the bearing portion 1102, with the bearing 1052 in abutted contact with a abutment surface 1104 of the flange 1094 of the shaft 1050.

In contrast to shaft 1040, only one bearing 1052 is mounted on the bearing portion 1102 (see FIG. 9) and the ratio between the bearing portion 1102 relative to the gear portion 1100 is between 0.5 and 1.5. However, more than one bearing may be mounted on the bearing portion 1102. Similar to the shaft 1040, the diameter of the first bearing portion 1102 is smaller than a diameter of the flange 1094 of the shaft 1050. Further, the diameter of the gear portion 1100 is smaller than both, the diameter of the flange 1094 of the shaft 1050 and the diameter of the first bearing portion 1102 of the shaft 1050.

The connection region 1090 has a threaded hole 1098, used for mounting the chuck 1020 (see FIG. 1) to the shaft 1050. However, the connection region may also have an outer threaded periphery, as described with respect to the first embodiment.

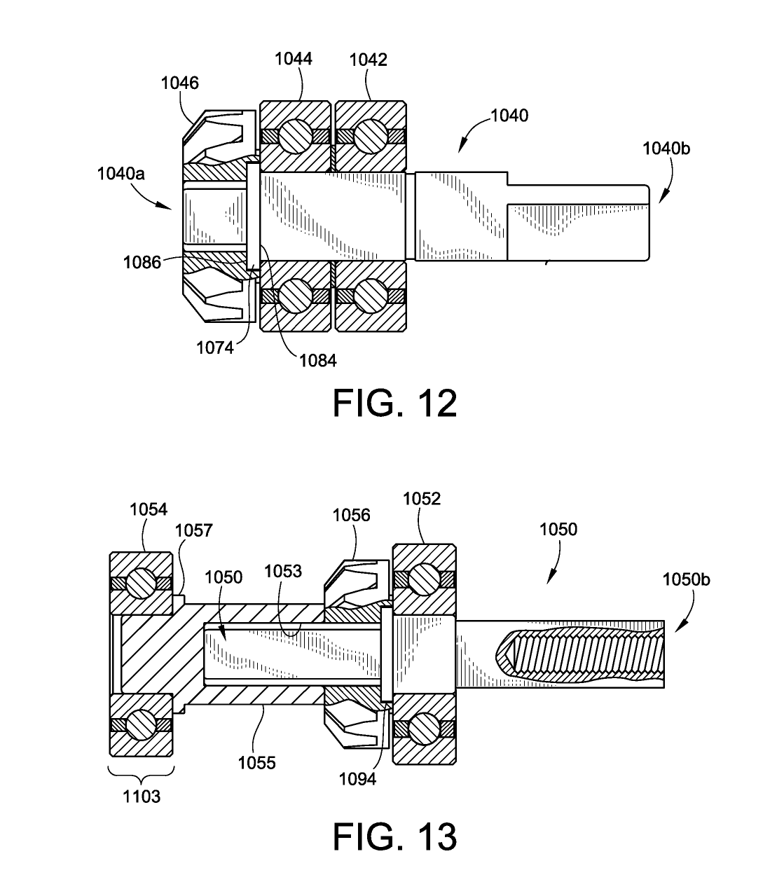

With reference to FIG. 12, the bearings 1042, 1044 of the first transmission assembly 1030 (see FIG. 9) are illustrated mounted on the shaft 1040. The bearings 1042, 1044 can be mounted on the shaft 40 using a press fit to insure sufficient contact of the shaft 1040 relative to the bearings 1042, 1044. The bearings 1042, 1044 can be embodied as a variety of rolling element bearings such as ball bearings, roller bearings, needle bearings, or bushings. Additionally, each one of the bearings 1042, 1044 may be different or the same type of bearing as each other one of the bearings 1042, 1044.

When mounted to the shaft 1040, the bearings 1042, 1044 can abut against one another or be spaced apart with one bearing 1044 abutting against the first side abutment 1084 of the shaft 1040. The bearing portion 1082 with the bearings 1042, 1044 extends axially away from the first side abutment 1084 of the flange 1074. When installed as illustrated, the bearings provide a bearing support region taken from the abutment 1084 to an outer edge of the bearing 1042 farthest away from the abutment 1084. The flange 1074 is arranged between the bearing 1044 mounted on the shaft 1040 and the gear 1046 mounted on the shaft 1040.

The gear 1046 of the first transmission assembly 1030 is also illustrated mounted to the shaft 1040. The gear 1046 is carried by the shaft on the gear portion 1080 and is operable to mesh with a second gear (for instance gear 1056) at a mesh point. The gear 1046 is a bevel gear and an outer periphery of the gear is substantially tapering in a direction from the second end 1040b of the shaft 1040 to the first end 1040a of the shaft 1040. The gear 1046 is in abutted contact with the second side abutment 1086 of the flange 1074. The gear portion 1080 extends axially away from the second side abutment 1086 of the flange 1074. The gear 1046 may be mounted to the shaft 1040 using a press fit to insure sufficient contact between the shaft 1040 and the gear 1046. The gear 1046 may be a bevel gear or other gear typically used to transfer torque between non-parallel axes. In connection with the substantially flat end face at the first end 1040a of the shaft 1040, the gear 1046 is flush with the end face of the first end 1040a of the shaft 1040. The shaft 1040 can be used in a right angle drive in order to transfer an input torque from a first end of the right angle drive (for instance the input shaft 1060) to a second end of the right angle drive (for instance the chuck 1020).

Turning now to FIG. 13, the shaft 1050 from FIG. 11 is shown, now with the first bearing 1052 mounted to shaft 1050 on the first bearing portion 1102 and radially supporting the shaft 1050. The end piece 1055 provides the second bearing portion 1103 for the second bearing 1054. The diameter of the second bearing portion 1103 is smaller than the diameter of the flange portion 1094. The shaft 1050 has at its first end 1050a a connection region 1091 for connecting the shaft 1050 to the end piece 1055. The second bearing 1054 is a thrust bearing configured to at least axially support the shaft 1050 over the second bearing portion 1103 which is provided by the end piece 1055. In particular, the second bearing 1054 supports the shaft against a thrust from the second end 1050b to the first end 1050a of the shaft. However, the second bearing 1054 may also provide radial support for the shaft 1050. When installed as illustrated, the bearings provide a first and a second bearing support region defined by the outer periphery of the two bearings 1052, 1054.

The end piece 1055 has a receiving portion 1053 in the form of a recess for receiving the connection region 1091 of the first end 1050a of the shaft 1050. Thus, the inner periphery of the receiving portion 1053 is adapted to the outer periphery of the connection region 1091 of the shaft 1050. The diameter of the end piece 1055 in the connection region is smaller than the diameter of the gear 1056. The end piece 1055 has a flange 1057 adjacent to the second bearing portion 1103. While the first bearing 1052 is in abutted contact with the abutment 1104 of the flange 1094 of the shaft 1050, the second bearing 1054 is in abutted contact with an abutment of the flange 1057 of the end piece 1055. As can be seen, the end piece 1055 is a separate piece from the shaft 1050. However, as already described above, the end piece 1055 may be designed integral with shaft 1050, such that end piece 1055 is a part of shaft 1050.

The flange 1094 is arranged between the bearing 1052 mounted on the shaft 1050 and the gear 1056 mounted on the shaft 1050. Similar to the gear 1046, the gear 1056 is a bevel gear and an outer periphery of the gear 1056 is substantially tapering in a direction from the second end 1050b of the shaft 1050 to the first end 1050a of the shaft 1050.

In this case, both, first bearing 1052 and the second bearing 1054 are ball bearings. However, they can be embodied as a variety of rolling element bearings such as ball bearings, roller bearings, needle bearings, or bushings. In a similar manner as that discussed above with respect to FIG. 12, the bearing 1052 of the second transmission assembly 1032 can be press fit to the shaft 1050.

The shaft 1050 can be used in a right angle drive in order to transfer an input torque from a first end of the right angle drive (for instance the input shaft 1060) to a second end of the right angle drive (for instance the chuck 1020).

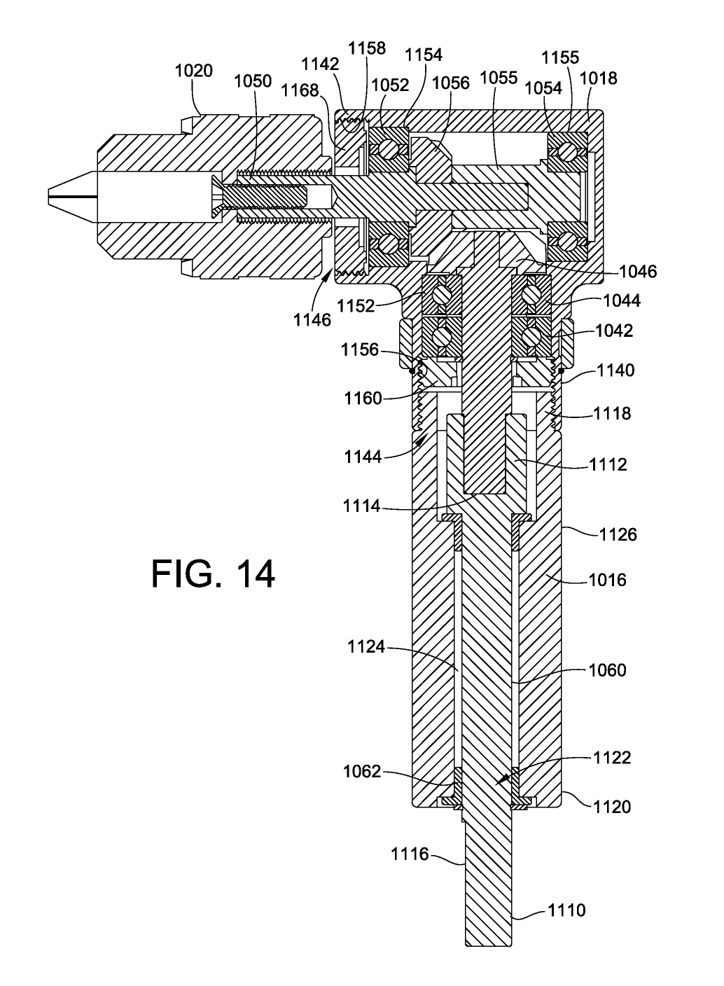

Turning now to FIG. 14, the right angle 1012 is designed similar to the embodiment illustrated in FIG. 7. The input shaft 1060 is used to transmit a torque through the first and second transmission assemblies 1030, 1032 (see FIG. 9) to the chuck 1020. The input shaft 1060 has a first end 1110 and a second end 1112. The first end 1110 has an outer peripheral surface 1116. The outer peripheral surface 1116 is defined by a cross-sectional profile that can be straight, hexagonal, triangular, or any other profile commonly used in rotational mechanisms. The second end 1112 has an opening 1114 therein. The opening 1114 is used to connect the input shaft 1060 to the connection region (see FIG. 10) of the shaft 1040 of the first transmission assembly 1030 (see FIG. 9).

The handle 1016 has a first end 1118 and a second end 1120. The second end 1120 has a bore 1122 passing there through to allow the first end 1110 of the input shaft 1060 to extend from the handle 1016 for connection to a drill 14 (see FIG. 1) or similar device. The first end 1118 is threaded for connecting the handle 1016 to the elbow 1018. The remainder of the input shaft 1060 is disposed within a cavity 1124 of the handle 1016. As illustrated in FIG. 14, the cavity 1124 of the handle 1016 also carries an input bearing 1062 that support the input shaft 1060. Also, as illustrated in FIG. 14, the connection between the shaft 1040 of the first transmission assembly 1030 (see FIG. 9) and the input shaft 1060 occurs within the cavity 1124 of the handle 1016.

The handle 1016 also has an outer peripheral surface 1126. The outer peripheral surface 1126 can be smooth or include other surface features such as finger indentations, gratings, rubberized grips, etc. Additionally, the handle 1016 is generally interchangeable with other handles by removing the handle 1016 from the elbow 1018 and replacing it with a different handle.

The elbow 1018 has a first end 1140 and second end 1142. The first end threadably receives the handle 116. The chuck 1020 mounts to the shaft 1050 of the second transmission assembly 1032 (see FIG. 9) proximate the second end 1142 of the elbow 1018.

The elbow 1018 has first and second cavities 1144, 1146 internally therein. The first and second cavities 1144, 1146 are in communication with one another. The gear 1046 and bearings 1042, 1044 of the first transmission assembly 1030 (see FIG. 9) are disposed within the first cavity 1144. The gear 1056 and bearings 1052, 1054 of the second transmission assembly 1032 (see FIG. 9) are disposed within the second cavity 1146. The gears 1046, 1056 mesh at the union of the first and second cavities 1144, 1146.

Since the first end 1040a of shaft 1040 (see FIG. 12) has a substantially flat end face and the gear 1046 is flush with the end face of the first end 1040a of shaft 1040, gear 1046 can mesh with gear 1056 and at the same time shaft 1050 and end piece 1055 can extend beyond gear 1056. Thus, the bearing 1054 can be positioned on the other side of gear 1056 compared to bearing 1052, that is near the first end 1050a of shaft 1050. As a result shaft 1050 is supported by bearings 1052, 1054 on each side of gear 1056, leading to an improved load distribution along shaft 1050 and at the same time providing a compact right angle drive.

When fully installed, the bearings 1042, 1044 are in surface contact with an internal bearing surface 1152 of the cavity 1144 having a width sufficient to accept the bearings 1042, 1044. The bearings 1042, 1044 may be installed within the first cavity 1144 by a press fit to insure sufficient engagement with the first cavity 1144. Additionally, the first cavity 1144 also includes a threaded internal periphery 1156 for receipt of the retainer ring 1160 to insure the bearings 1042, 1044 are sufficiently retained within the first cavity 1144. Likewise, when fully installed, the bearings 1054, 1056 are each in contact with corresponding bearing surfaces 1154, 1155 of the second cavity 1146. The bearing surfaces 1154, 1155 each having a width sufficient to accept one of the bearings 1052, 1054. The bearings 1054, 1056 may be press fit within the second cavity 1146 to insure sufficient engagement with the elbow 1018. Additionally, the second cavity 1146 also includes a threaded internal periphery 1158 for receipt of the retainer ring 1168 to aid in retaining the second transmission assembly 1032 (see FIG. 9) within the second cavity 1146.

The connection region 1090 (see FIG. 11) extends from the second end 1142 of the elbow 1018. The chuck 1020 has a threaded part to threadably engage the threaded hole 1098 of shaft 1050.

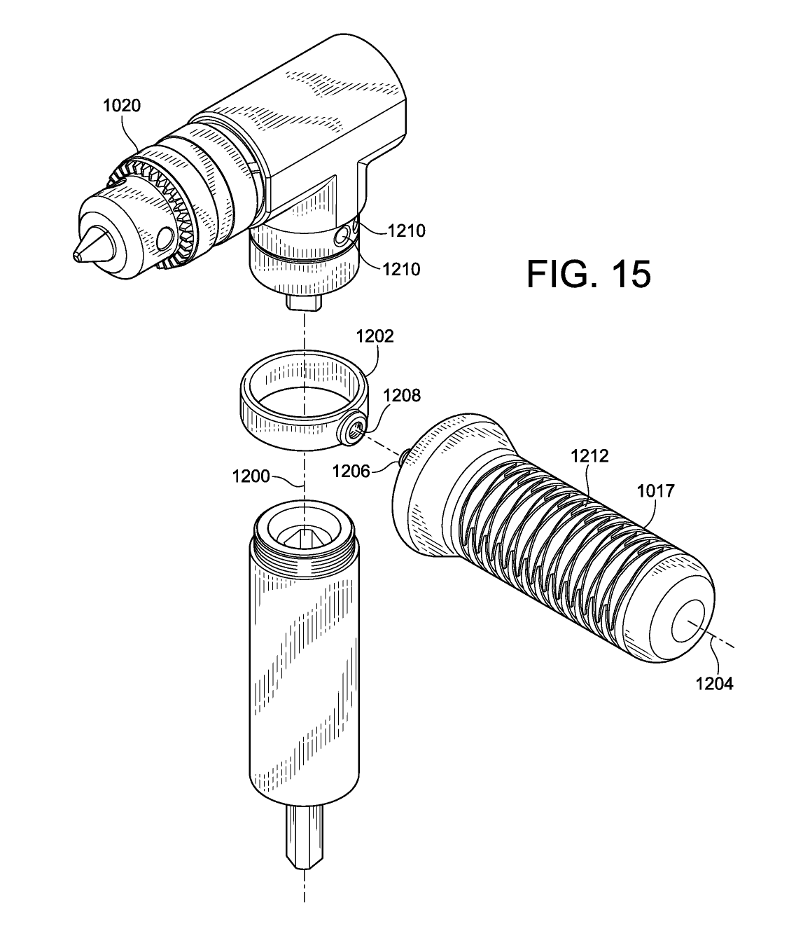

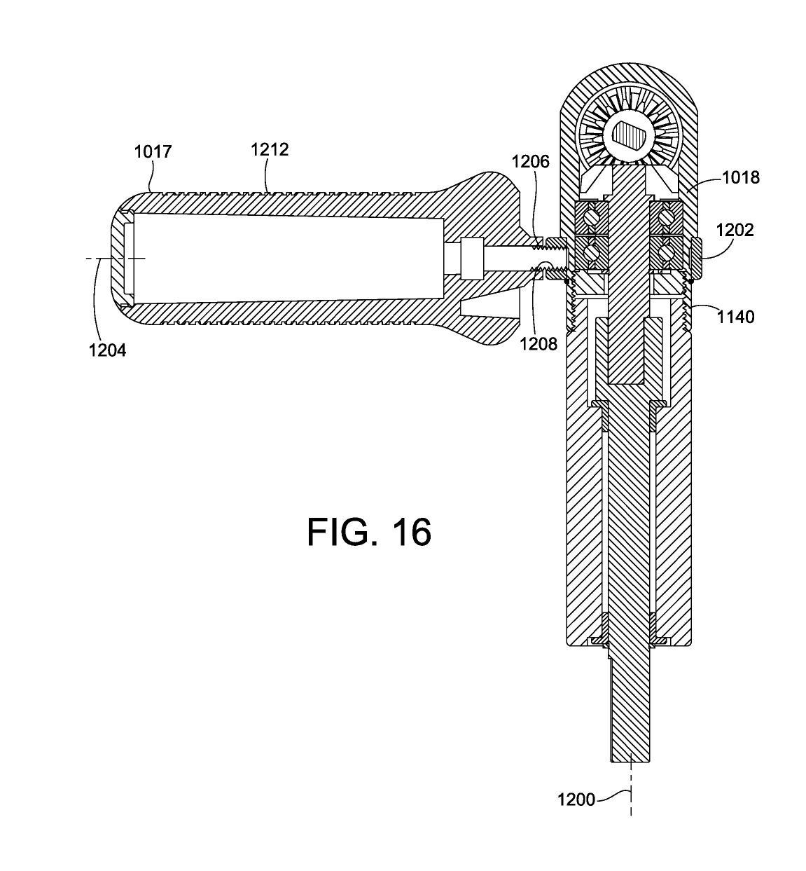

Turning now to FIGS. 15 and 16, the (additional) handle 1017 is illustrated in greater detail. The handle 1017 is attached to the housing in the region of the first end 1140 of the elbow 1018. The handle 1017 has an outer peripheral surface 1212. The outer peripheral surface 1212 can be smooth or include other surface features such as finger indentations, gratings, rubberized grips, etc. Additionally, the handle 1017 is generally interchangeable with other handles by removing the handle 1017 from the elbow 1018 and replacing it with a different handle.

The handle 1017 is rotatable about an axis of rotation 1200, which is in this case the axis of input shaft 1040. As a result the handle 1017 is rotatable about the housing. However, the handle 1017 may also be rotatable about the axis of the output shaft 1050, for instance.

The handle 1017 is attached to the first end 1140 of the elbow 1018 over a ring element 1202. Both, the handle 1017 and the ring element 1202 are commonly rotatable over the axis of rotation 1200. The handle 1017 has an axis 1204 which is perpendicular to the axis of rotation 1200.

The handle 1017 comprises at one end an outer periphery with a thread 1206. The ring element 1202 comprises an inner periphery with a thread 1208, such that the handle 1017 can be screwed into the ring element 12020. If the handle 1017 is screwed into the ring element 1202 far enough by rotating the handle 1017 about axis 1204, the position of the handle 1017 and the ring element 1202 are fixed relative to the elbow 1018 and thus the housing. However, it may be possible that at least one of the handle and the ring element having another fixation mechanism for fixing the position of the handle relative to the housing.

The housing may comprise indicators 1210 indicating predefined positions of the handle 1017 relative to the housing. The indicators are designed as recesses, which may for instance define one or more predefined positions of handle 1017. For instance, the recesses may indicate one or more positions, i.e. amount of rotation about axis 1200, such as 0, 45, 90, 135, and 180 degrees. This helps aligning handle 1017.

As described herein, embodiments of the invention provide right-angle drives 12, 1012 that incorporates first and second transmission assemblies 30, 32; 1030, 1032 that have enhanced load-bearing capabilities over prior designs by incorporating multiple bearings for each shaft 40, 50; 1040, 1050 of each transmission assembly 30, 32; 1030, 1032. By incorporating multiple bearings per shaft, the bearings have a longer life span such that the right-angle drives 12, 1012 have a longer life span than prior designs, while at the same time compact and easy to use right-angle drives are provided.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

All references, including publications, patent applications, and patents cited herein are hereby incorporated by reference to the same extent as if each reference were individually and specifically indicated to be incorporated by reference and were set forth in its entirety herein.

The use of the terms “a” and “an” and “the” and similar referents in the context of describing the invention (especially in the context of the following claims) is to be construed to cover both the singular and the plural, unless otherwise indicated herein or clearly contradicted by context. The terms “comprising,” “having,” “including,” and “containing” are to be construed as open-ended terms (i.e., meaning “including, but not limited to,”) unless otherwise noted. Recitation of ranges of values herein are merely intended to serve as a shorthand method of referring individually to each separate value falling within the range, unless otherwise indicated herein, and each separate value is incorporated into the specification as if it were individually recited herein. All methods described herein can be performed in any suitable order unless otherwise indicated herein or otherwise clearly contradicted by context. The use of any and all examples, or exemplary language (e.g., “such as”) provided herein, is intended merely to better illuminate the invention and does not pose a limitation on the scope of the invention unless otherwise claimed. No language in the specification should be construed as indicating any non-claimed element as essential to the practice of the invention.

Preferred embodiments of this invention are described herein, including the best mode known to the inventors for carrying out the invention. Variations of those preferred embodiments may become apparent to those of ordinary skill in the art upon reading the foregoing description. The inventors expect skilled artisans to employ such variations as appropriate, and the inventors intend for the invention to be practiced otherwise than as specifically described herein. Accordingly, this invention includes all modifications and equivalents of the subject matter recited in the claims appended hereto as permitted by applicable law. Moreover, any combination of the above-described elements in all possible variations thereof is encompassed by the invention unless otherwise indicated herein or otherwise clearly contradicted by context.

What is claimed is:

1. A right angle drive, comprising:
at least one shaft having a first end, a second end and a first bearing portion, the shaft being configured to transmit an input torque to an output end of the right angle drive,
a first bearing mounted to the at least one shaft on the first bearing portion and radially supporting the shaft; and
a second bearing, the second bearing being a thrust bearing configured to at least axially support the at least one shaft over a second bearing portion.

2. The right angle drive of claim 1, wherein an end piece is provided, the end piece providing the second bearing portion for the second bearing and the shaft has at its first end a connection region for connecting the shaft to the end piece.

3. The right angle drive of claim 2, wherein the end piece has a receiving portion for receiving the first connection region of the first end of the shaft.

4. The right angle drive of claim 3, wherein the end piece has a flange adjacent to the second bearing portion, a diameter of the second bearing portion being smaller than a diameter of the flange portion.

5. The right angle drive of claim 4, wherein the end piece is a separate piece from the shaft.

6. The right angle drive of claim 5, wherein the second bearing is in abutted contact with an abutment of the flange of the end piece.

7. The right angle drive of claim 1, wherein the shaft has a flange adjacent to the first bearing portion, a diameter of the first bearing portion being smaller than a diameter of the flange of the shaft.

8. The right angle drive of claim 7, wherein the first bearing is in abutted contact with an abutment of the flange of the shaft.

9. The right angle drive of claim 7, wherein the shaft comprises a gear portion adjacent to the flange of the shaft.

10. The right angle drive of claim 9, wherein the gear portion is arranged between the first bearing portion and the first end of the shaft.

11. The right angle drive of claim 1, further comprising a housing, wherein the first and the second bearing have an outer periphery that define bearing support regions, the bearing support regions contacting an internal cavity of the housing, and the first and second bearing portion and the gear portion of the shaft internally disposed within the cavity of the housing.

12. A right angle drive, comprising:
at least one shaft operable to transfer an input torque from a first end of the right angle drive to a second end of the right angle drive, the at least one shaft having a flange, the flange being arranged between a bearing portion and a gear portion of the at least one shaft,
at least one bearing mounted on a bearing portion and radially supporting the shaft and in abutted contact with a first side abutment of the flange, the bearing portion extending axially away from the first side abutment of the flange; and
a first gear carried by the shaft on a gear portion, operable to mesh with a second gear at a mesh point and in abutted contact with a second side abutment of the flange, the gear portion extending axially away from the second side abutment of the flange.

13. The right angle drive of claim 12, wherein one bearing is mounted on the bearing portion and the ratio between the bearing portion relative to the gear portion is between 0.5 and 1.5.

14. The right angle drive of claim 13, wherein at least a second bearing is provided, the second bearing being a thrust bearing configured to axially support the at least one shaft over a second bearing portion.

15. The right angle drive of claim 14, wherein an end piece is provided, the end piece providing the second bearing portion for the second bearing and the shaft has at a first end a connection region for connecting the shaft to the end piece.

16. The right angle drive of claim 12, wherein at least two bearings are mounted on the bearing portion and the ratio between the bearing portion relative to the gear portion is larger than 1.5.

17. The right angle drive of claim 16, wherein the gear portion forms a first end of the shaft having a substantially flat end face.

18. The right angle drive of claim 17, wherein the gear is flush with the end face of the first end.

19. A right angle drive, comprising:
a first shaft having a flange;
a second shaft having a flange;
a first gear mounted to the first shaft;
a second gear mounted to the second shaft, the gears meshing to operably transfer an input torque between the first and the second shafts;
a first number of bearings supporting the first shaft, the flange of the first shaft being arranged between the first gear and the first number of bearings; and
a second number of bearings supporting the second shaft, the second number of bearings being at least two, the flange of the second shaft and the second gear being arranged between the second number of bearings.

20. The right angle drive of claim 19, wherein the first number of bearings is at least two and is mounted on a bearing region of the first shaft adjacent the flange of the first shaft

21. The right angle drive of claim 19, wherein at least one of the second number of bearings is mounted on a bearing region of the second shaft adjacent the flange of the second shaft

22. The right angle drive of claim 21, wherein at least one of the second number of bearings is mounted on a bearing region of an end piece.

23. A right angle drive, comprising:
a housing
an input shaft rotatably mounted within the housing for rotation about an input axis;
an output shaft rotatably mounted within the housing for rotation about an output axis, the input shaft operably coupled to the output shaft to transmit torque there between,
a handle attached to the housing and at least partially rotatable about an axis of rotation, such that the handle is at least partially rotatable about the housing.

24. The right angle drive of claim 23, wherein the axis of rotation is one of the input and the output axis.

25. The right angle drive of claim 24, wherein the handle is attached to the housing over a ring element, the handle and the ring element being commonly rotatable over the axis of rotation.
